(19) United States
(12) Patent Application Publication
(10) Pub. No.: US 2010/0070656 A1
(43) Pub. Date: Mar. 18, 2010

(54) SYSTEM AND METHOD FOR ENHANCED LOAD BALANCING IN A STORAGE SYSTEM

(75) Inventors: David A. Snell, Youngstown, NY (US); Michael M. Boncaldo, Amherst, NY (US); David J. Cuddihy, Hamburg, NY (US)

Correspondence Address: PHILLIPS LYTLE LLP;INTELLECTUAL PROPERTY GROUP, 3400 HSBC CENTER, BUFFALO, NY, 14203-3509, US

(73) Assignee: ATTO TECHNOLOGY, INC., Amherst, NY (US)

(21) Appl. No.: 12/558,002

(22) Filed: Sep. 11, 2009

Related U.S. Application Data
(60) Provisional application No. 61/191,856, filed on Sep. 12, 2008.

(51) Int. Cl. G06F 3/00

(52) U.S. Cl. 710/5

(57) ABSTRACT

In association with a storage system, dividing or splitting file system I/O commands, or generating I/O subcommands, in a multi-connection environment. In one aspect, a host device is coupled to disk storage by a plurality of high speed connections, and a host application issues an I/O command which is divided or split into multiple subcommands, based on attributes of data on the target storage, a weighted path algorithm and/or target, connection or other characteristics. Another aspect comprises a method for generating a queuing policy and/or manipulating queuing policy attributes of I/O subcommands based on characteristics of the initial I/O command or target storage. I/O subcommands may be sent on specific connections to optimize available target bandwidth. In other aspects, responses to I/O subcommands are aggregated and passed to the host application as a single I/O command response.

### PRIORITY CLAIM

The present application claims priority to U.S. Provisional Patent Application No. 61/191,856, filed Sep. 12, 2008.

### TECHNICAL FIELD

The invention relates generally to computer systems and, more particularly, to computer storage systems and load balancing of storage traffic.

### BACKGROUND OF THE INVENTION

In most computer systems, data is stored in a device such as a hard disk drive. This device is connected to the CPU either by an internal bus or through an external connection such as serial-attached SCSI or fibre channel. In order for a host software application to access stored data, it typically passes commands through a software driver stack (see example in FIG. 1). Host applications communicate with hardware storage devices through a series of software modules, known collectively as a driver stack. A host application interfaces with a software driver at the top of the stack, and a software driver at the bottom of the stack communicates directly with the hardware. As a storage I/O command passes through each layer of the driver stack, more detail is added to the command, such as the physical address of the storage, the logical block address of the data on the storage, the number of blocks to be read or written, and queuing attributes of the storage command.

Software drivers interact with the storage at various levels of abstraction. Different types of storage can be connected without changes to the file system or software application. As commands move up a software driver stack, the representation of the data becomes more and more abstract. Lower layers of the software stack, performing block level I/O, have much more detailed information about the physical layout of the data than do the OS, file system or host application, for example.

Many high performance storage systems use a technology called RAID, which stands for Redundant Array of Independent Disks. RAID technology generally refers to the division of data across multiple hard disk drives. The performance of parity-based RAID is dependent on the types of storage commands issued. Since parity calculations are performed on fixed-sized boundaries, the size and offset of I/O commands can cause wide variations in RAID performance. The performance of parity-based RAID is also dependent on the order of storage commands received and the type of caching in use by the RAID algorithm.

Computer storage systems which communicate using the SCSI Architecture Model (SAM) utilize a set of attributes known collectively as tagged command queuing. With tagged command queueing each I/O command has a queueing policy attribute that specifies how a target storage device is to order the command for execution. Command tags can specify SIMPLE, ORDERED or HEAD OF QUEUE. I/O commands with the HEAD OF QUEUE task attribute must be started immediately, before any dormant ORDERED or SIMPLE commands are executed. I/O commands with the ORDERED tag must be executed in order, after any I/O commands with the HEAD OF QUEUE attribute but before any I/O commands with the SIMPLE attribute. I/O commands with the SIMPLE task attribute must wait for HEAD OF QUEUE and ORDERED tasks to complete. I/O commands with the SIMPLE task attribute can also be reordered at the target.

The overall latency of an I/O command is dependent on queuing attributes attached to the command. Many I/O commands sent by a computer system to a block-based storage device are issued with the SIMPLE tag, giving the target storage device control over the latency of each I/O command.

Many existing host applications issue large, serialized read and write commands and only have a small number of storage commands outstanding at one time, leaving most of the storage connections underutilized.

### SUMMARY OF INVENTION

Broadly, the invention comprises a system, method and mechanism for dividing file system I/O commands into I/O subcommands. In certain aspects, the size and number of I/O subcommands created is determined based on, or as a function of, a number of factors, including in certain embodiments storage connection characteristics and/or the physical layout of data on target storage devices. In certain aspects, I/O subcommands may be issued concurrently over a plurality of storage connections, decreasing the transit time of each I/O command and resulting in an increase of overall throughput.

In other aspects of the invention, by splitting storage commands into a number of I/O subcommands, a host system can create numerous outstanding commands on each connection, take advantage of the bandwidth of all storage connections, and provide effective management of command latency. Splitting into I/O subcommands may also take advantage of dissimilar connections by creating the precise number of outstanding I/O subcommands for the given connection parameters. Overlapped commands may also be issued, fully utilizing storage command pipelining and data caching technologies in use by many targets.

Algorithms for splitting commands may be based on a number of dynamic factors. Certain aspects of the present invention provide visibility into the entire storage subsystem, and facilities for creating I/O subcommands based on dynamic criteria, such as equipment failures, weighted paths and dynamically adjusted connection speeds.

Certain aspects of the invention comprise criteria for splitting storage commands that can be customized to take advantage of the physical layout of the data on the target storage. The performance of storage commands in a RAID environment can degrade drastically based on a number of factors, such as the size of the storage command, offsets into the physical storage, and the RAID algorithm used. In some aspects of the invention, the creation of I/O subcommands may take these factors into account, resulting in substantially higher system performance. The use of these attributes may be particularly effective when the physical layout of the storage is determined automatically, allowing novice users to optimize the performance of a multipath storage system, for example.

In one aspect, the invention provides a method of processing I/O commands in a computer storage system having a host device capable of issuing I/O commands, a software driver residing on said host device capable of receiving and processing said I/O commands, a plurality of associated storage devices, and a plurality of I/O connections between said host device and said associated storage devices, comprising: receiving an I/O command from a host device which specifies a data transfer between the host and a storage device; determining the amount of data to be transferred; comparing the amount of data to a threshold data size; if said amount of data exceeds the threshold, generating a plurality of I/O subcommands, each comprising a portion of the I/O command; and sending the I/O subcommands concurrently over a plurality of I/O connections.

Other aspects of the invention include determining the number of outstanding I/O subcommands on the I/O connections, wherein the number of I/O subcommands generated is determined as a function of the number of outstanding I/O subcommands; computing the average time to complete an I/O subcommand on I/O connections, wherein the number or size of I/O subcommands generated is determined as a function of that average time; determining the weighted average of I/O connection throughput, wherein the I/O subcommands are generated as a function of the weighted average; and/or determining the logical characteristics of associated storage devices and determining the number or size of I/O subcommands generated as a function of such logical characteristics.

Another aspect comprises receiving responses from one or more of the I/O subcommands, aggregating those responses into a single aggregated response; and sending a single aggregated response to the requestor or issuer of the initial I/O command. Yet another aspect includes determining dynamic I/O throughput, wherein threshold data size is calculated as a function of the dynamic I/O throughput. Still another aspect comprises measuring the I/O throughput of each I/O connection over time, wherein the size of I/O subcommands generated is determined as a function of the I/O throughput for a corresponding I/O connection and the I/O subcommands generated are of different sizes. In another aspect, the invention includes determining the offset of I/O subcommands from the start of the original I/O command and generating a queuing policy for I/O subcommands as a function of said offset. Alternatively, a queuing policy is generated for I/O subcommands as a function of time; or as a function of logical block addresses of one or more I/O subcommands. Further aspects include determining a logical block address distance between subsequent I/O subcommands, comparing the logical block address distance to a predetermined threshold, and, if the predetermined threshold is exceeded, generating a queuing policy for the I/O subcommands such that they are executed in order. Criteria for generating I/O subcommands may be user configurable through a graphical user interface, configuration files or command line interface. Another aspect of the invention comprises determining the number of I/O connections which are active, issuing a notification each time the number changes, and storing the notifications in host memory; and determining the number or size of I/O subcommands generated as a function of those notifications.

In another aspect, the invention provides a method of processing I/O commands in a storage system having a host device capable of issuing I/O commands, a software driver residing on said host device capable of receiving and processing said I/O commands, a plurality of associated storage devices, and a plurality of I/O connections between said host device and said associated storage devices, comprising: receiving an I/O command from a host device; generating a plurality of I/O subcommands, each I/O subcommands comprising a portion of the I/O command; determining the offset of at least one of the I/O subcommands, as determined from the start of the original I/O command; generating a queuing policy for generated I/O subcommands as a function of the offset; and issuing I/O subcommands concurrently over a plurality of I/O connections in accordance with the queuing policy. The method may include some or all of the following steps: generating a queuing policy for I/O subcommands as a function of time; determining the logical block address of an I/O subcommand, generating a queuing policy for I/O subcommands as a function of the logical block address, and issuing I/O subcommands concurrently over a plurality of I/O connections according to the queuing policy; and/or sending an I/O subcommand using ORDERED tagging to limit the maximum latency of I/O subcommands.

Other aspects of the invention include systems for processing I/O commands in a computer storage system with a host device capable of issuing I/O commands, said host device coupled to a plurality of storage devices via a plurality of I/O connections; and software drivers, host memory driver stack(s), memory, controller(s), storage device(s), disk drive(s), disk drive array(s), RAID array(s), host storage adapters and other component(s) and/or device(s) for performing the foregoing methods and method steps.

Some benefits and advantages which may be provided by the present invention have been described above with regard to specific embodiments. These benefits and advantages, and any elements or limitations that may cause them to occur or to become more pronounced are not to be construed as a critical, required, or essential features of any or all of the claims. Other objects and advantages of the invention may become apparent upon reading the following detailed description and upon reference to the accompanying drawings.

While the invention is subject to various modifications and alternative forms, specific embodiments thereof are shown by way of example in the detailed description. It should be understood, however, that the detailed description is not intended to limit the invention to the particular embodiment which is described. This disclosure is instead intended to cover all modifications, equivalents and alternatives falling within the scope of the present invention.

### BRIEF DESCRIPTION OF DRAWINGS

FIG. 1 is an example of a software driver stack in a host computer system.

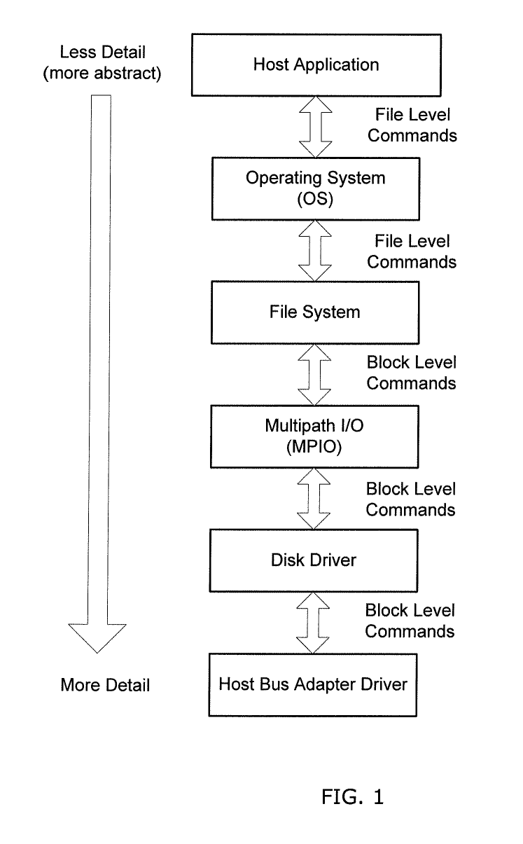

FIG. 2 illustrates storage I/O commands issued over multiple independent paths to redundant storage controllers.

FIG. 3 is an example of a storage system having a host CPU and a disk drive array with a plurality of hardware connections.

FIG. 4 illustrates I/O subcommands issued using a weighted path algorithm.

FIG. 5 illustrates an 8 MB read I/O command being split into eight separate 1 MB I/O subcommands by a host software driver stack.

FIG. 6 is an example of failure of a physical connection between a host CPU and a disk drive array.

FIG. 7 illustrates the use of a weighted path algorithm.

FIG. 8 illustrates the issue of I/O subcommands based on RAID array boundaries.

FIG. 9 illustrates the use of a queuing policy.

FIG. 10 is an example system with read-only and write-only physical connections.

FIG. 11 is an example system with a weighted read/write ratio.

### DESCRIPTION OF THE PREFERRED EMBODIMENTS

At the outset, it should be clearly understood that like reference numerals are intended to identify the same parts, elements or portions consistently throughout the several drawing figures, as such parts, elements or portions may be further described or explained by the entire written specification, of which this detailed description is an integral part. The following description of the preferred embodiments of the present invention are exemplary in nature and are not intended to restrict the scope of the present invention, the manner in which the various aspects of the invention may be implemented, or their applications or uses.

Generally, the invention comprises systems and methods for dividing I/O commands into smaller commands (I/O subcommands) after which the I/O subcommands are sent over multiple connections to target storage. In one embodiment, responses to the storage I/O subcommands are received over multiple connections and aggregated before being returned to the requestor. In one aspect, this I/O command division and response aggregation occurs in software within the host software driver stack. The size and number of I/O subcommands is determined in one embodiment based on a set of criteria gathered by the I/O splitting software. Examples of such criteria include, without limitation, the speed and number of connections to the target storage, errors on a target storage connection, the type of storage being accessed, host application issuing the commands, file system and target storage parameters such as RAID algorithm, number of drives in use and RAID interval size.

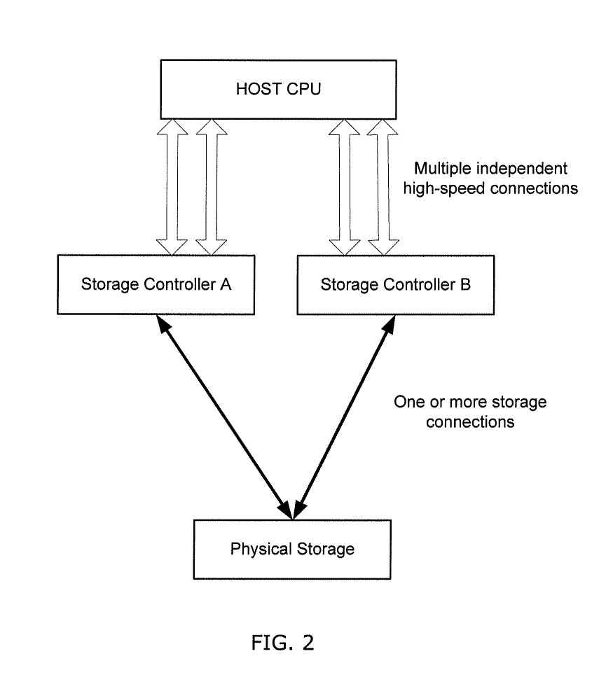

FIG. 2 is an example of storage I/O commands being issued over multiple independent paths to redundant storage controllers. Both storage controller A and storage controller B have access to the same physical storage through a number of independent connections. Failure of any single path or single storage controller will not cause the failure of the entire storage system. When no failures are present, the multiple paths and storage controllers can be used to enhance data throughput between the storage and the host CPU.

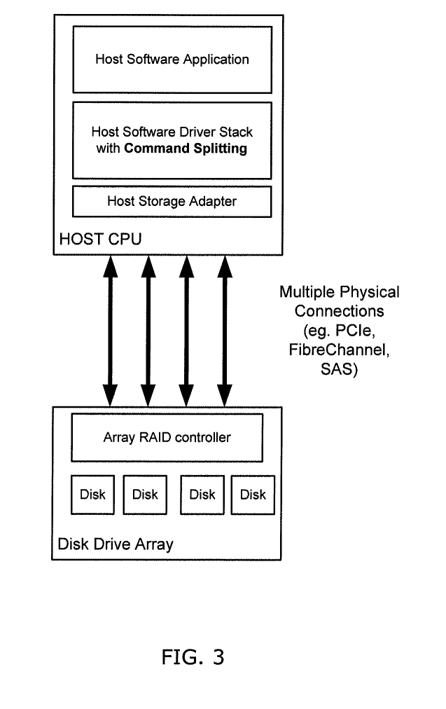

An exemplary system consists of a CPU communicating with a disk array through a plurality of hardware connections via a host storage adapter (as in the example illustrated in FIG. 3). This example includes a host CPU (also referred to as a “host device” or “host”) capable of issuing I/O commands, which host includes a host software application capable of creating I/O requests and a host software driver stack with command splitting. The host software application issues storage requests for large amounts of data through a file system. The file system creates storage I/O commands and issues the I/O commands to the hardware via a software driver stack for processing. A driver in the software stack monitors the state of the current system and splits the storage I/O command into I/O subcommands based on a number of configurable criteria. The I/O subcommands are issued concurrently on a number of physical connections.

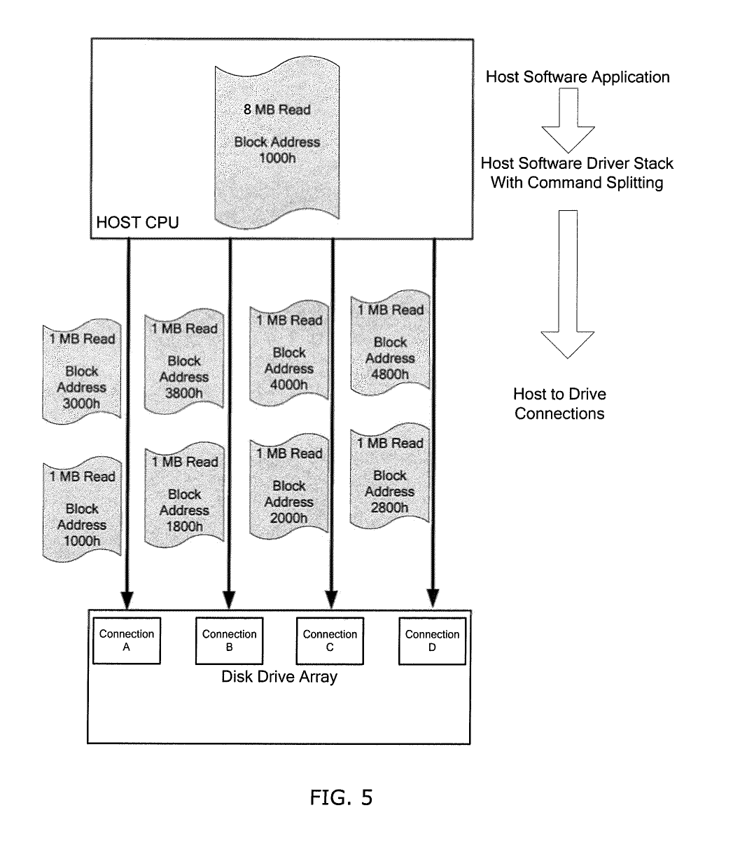

For example, the system illustrated in FIG. 5 shows a host connected to a target through four physical connections. When the host software application issues an 8 megabyte (8 MB) read command, the software driver stack splits the read command into 8 I/O subcommands, each 1 MB. All resulting commands can be issued simultaneously, creating overlapped I/O on all 4 connections. In this example, I/O subcommands are issued evenly across 4 physical connections.

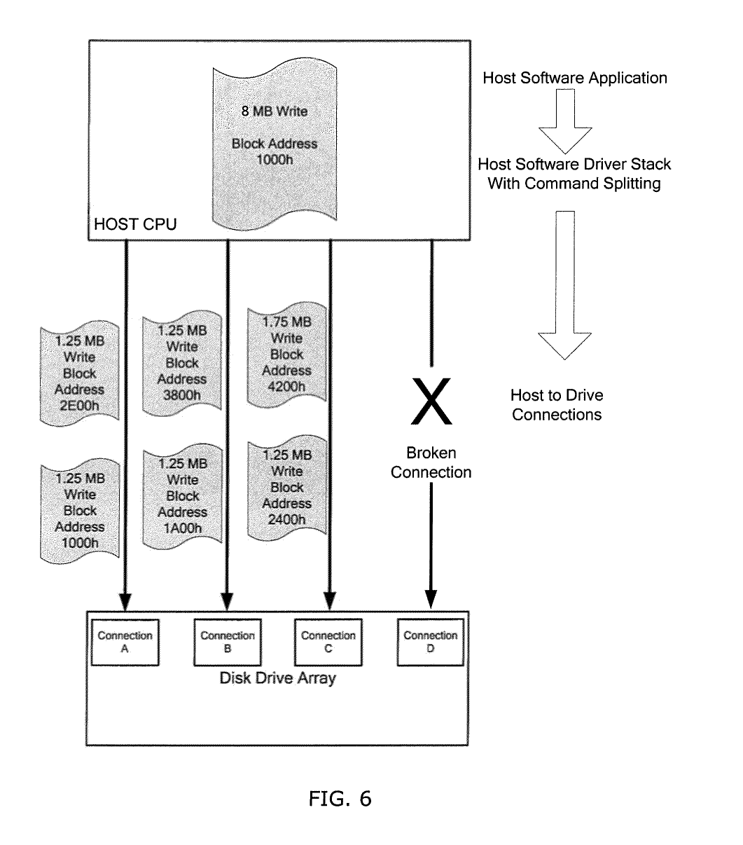

Another embodiment of the invention includes a method or means of keeping count of active connections to the target storage. When a connection to storage changes state between online and offline, the driver software issues a notification that the number of connections has changed. These notifications are stored in a list in host computer memory. The number of entries in this list determines the number and size of I/O subcommands to be generated to satisfy the initial storage command. If a connection is added, removed, or encounters too many errors to be considered for active use, the count can be adjusted. Subsequent large I/O commands will be divided into I/O subcommands using the adjusted number of connections. For example, using the system illustrated in FIG. 3 with four physical connections, if the host software application issues an 8 MB write command, the software driver may split the command into 8 I/O subcommands, each 1 MB. If the software driver for one of the physical connections determines the connection to be offline, the count of active connections is decremented to 3. The 8 MB write command is no longer evenly divisible by the number of connections, so the software driver stack in this example splits the command into 6 I/O subcommands as illustrated in FIG. 6, with 5 of the commands at 1.25 MB and one command at 1.75 MB. All commands can be issued simultaneously, this time making efficient use of 3 connections. FIG. 6 is an example of the failure of one of the physical connections between a host CPU and a disk drive array. An 8 MB write I/O command, which would normally be split into eight 1 MB I/O subcommands, is instead split into 6 total I/O subcommands of varying sizes, with I/O subcommands issued across the remaining 3 physical connections.

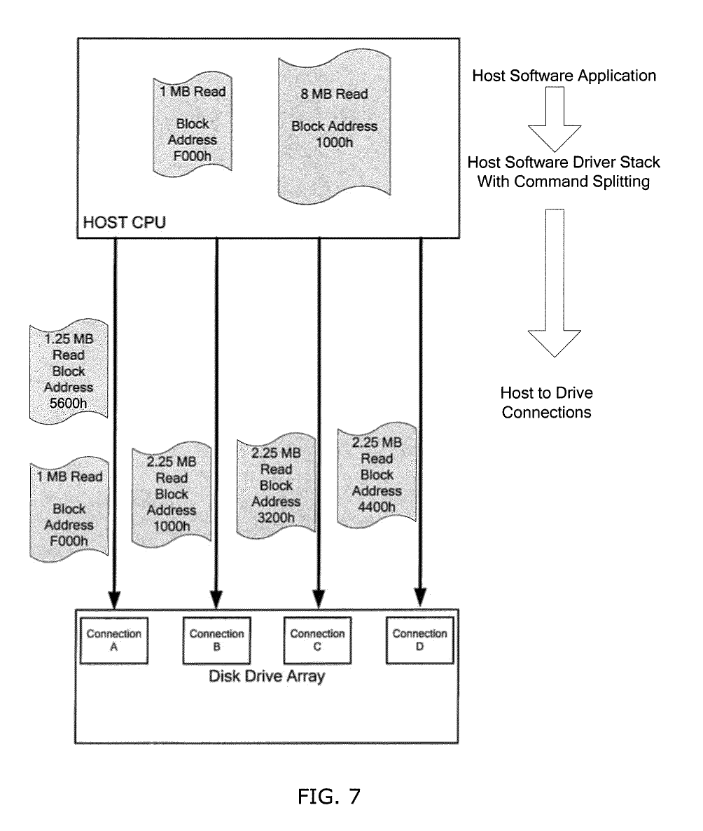

In another embodiment, the system keeps track of a number of metrics, such as the number of outstanding commands on each connection, average time to complete a command on a particular connection, weighted average of connection throughput, whether the command is a read or write, etc. These metrics are stored in host memory in a metric status table. The number of I/O subcommands generated for a single storage command is determined based on a real-time analysis of the stored metrics and the current state of the system. For example, the system may track the size of the data transfers outstanding on each connection. In a system with four connections as illustrated in FIG. 7, the host software application issues a 1 MB command followed by an 8 MB command. The 1 MB command is sent, as a whole, on connection A. The 8 MB command is split into four I/O subcommands, with a 1.25 MB command on connection A and 2.25 MB commands on connections B, C and D.

FIG. 7 is an example of I/O subcommands sent using a weighted path algorithm which keeps track of the number of bytes in flight on a particular physical connection. Two I/O commands are issued by the host application and four I/O subcommands are issued. I/O subcommand sizes are adjusted to balance the total amount of data in flight (2.25 MB in this example) on each connection.

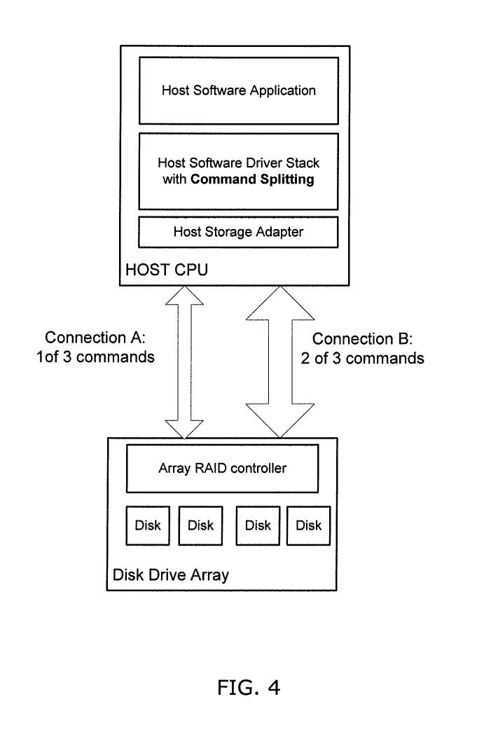

Another embodiment of the invention includes a method or means of determining the number of I/O subcommands by applying a weighted formula to the number of active connections to the target storage. This formula can generate the proper number of I/O subcommands to best match the needs of the weighting formula. For example, if two connections exist, but one command is to be sent on connection A for every two commands on connection B, the number of I/O subcommands to be generated from each command will be a multiple of three. FIG. 4 is an example of I/O subcommands being issued using a weighted path algorithm. The example system has two hardware connections between the host CPU and the disk drive array. The host software driver stack splits an I/O command into three I/O subcommands and issues two of the three commands on connection B. The remaining command is issued on connection A. Numerous other weighted formulas are also possible, such as setting a limit on the total amount of bandwidth used on a particular connection, or guaranteeing that the bandwidth used on one connection maintains a 3:1 ratio with the other connection, etc.

In some embodiments, the size of the I/O subcommands is determined by attributes of the physical layout of the data on the target storage. There are a number of attributes which may be considered, such as the RAID parity algorithm used, the number of target drives, the RAID interval size, the RAID stripe size and others known to those skilled in the art. The size and number of I/O subcommands can also be determined by the use of a combination of the number of connections, a weighted connection formula, and the physical layout of the target storage. In some cases the physical layout of the data may preclude the splitting of commands, since split commands may force the RAID algorithm to perform extra work to calculate parity, etc. In one embodiment, the physical layout of the data is queried from the target storage, by use of SCSI INQUIRY and MODE PAGE requests. The physical layout is then analyzed and if these cases are detected the software will avoid splitting the commands.

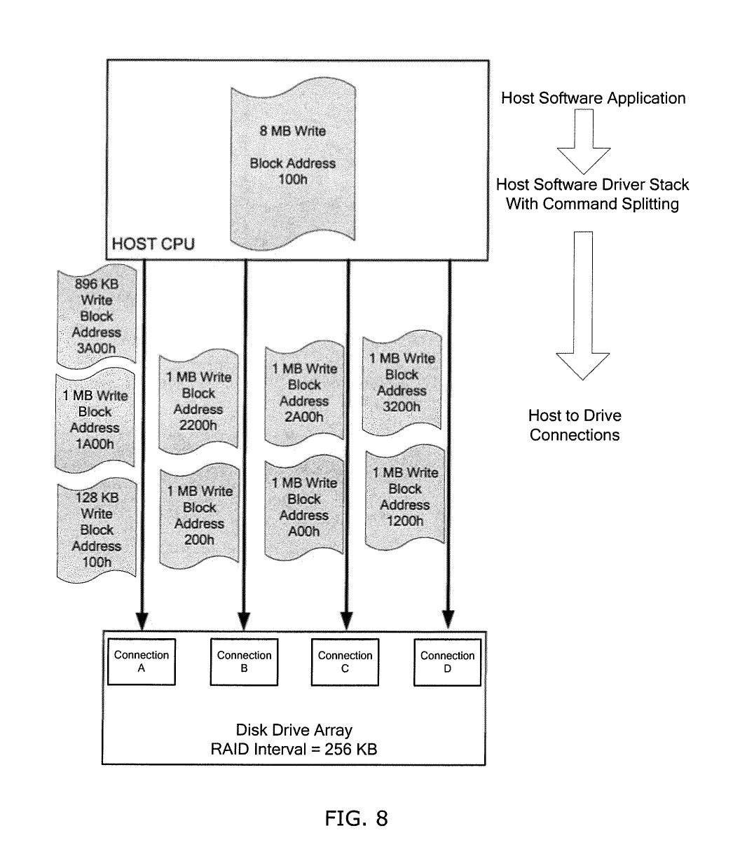

Another embodiment contains a means of creating I/O subcommands of different sizes at specific offsets into a single command. These different sized I/O subcommands may be generated based on the number and speed of connections to the storage, a weighted connection formula, attributes of the physical layout of the data on the target storage, or a combination of these factors. The system illustrated in FIG. 8, for example, shows a host CPU with four connections to a disk drive array using RAID. FIG. 8 is an example of the issue of I/O subcommands based on RAID array boundaries. The software driver stack has queried the disk drive for its RAID interval, 256 kilobytes (KB), and an 8 MB write command is issued with a block offset of 256 blocks (128 KB) into an interval. The host driver software now splits the command into nine I/O subcommands of varying sizes, adjusting the sizes and block addresses so that the maximum number of I/O subcommands start and end on RAID interval boundaries. The first subcommand contains enough data (128 KB) to align subsequent commands on an interval boundary. Seven 1 MB I/O subcommands follow, each command aligned to start at an interval boundary, followed by an 896 KB command to complete the read request. The two smaller commands are sent on the same connection in order to balance the data throughput of each connection.

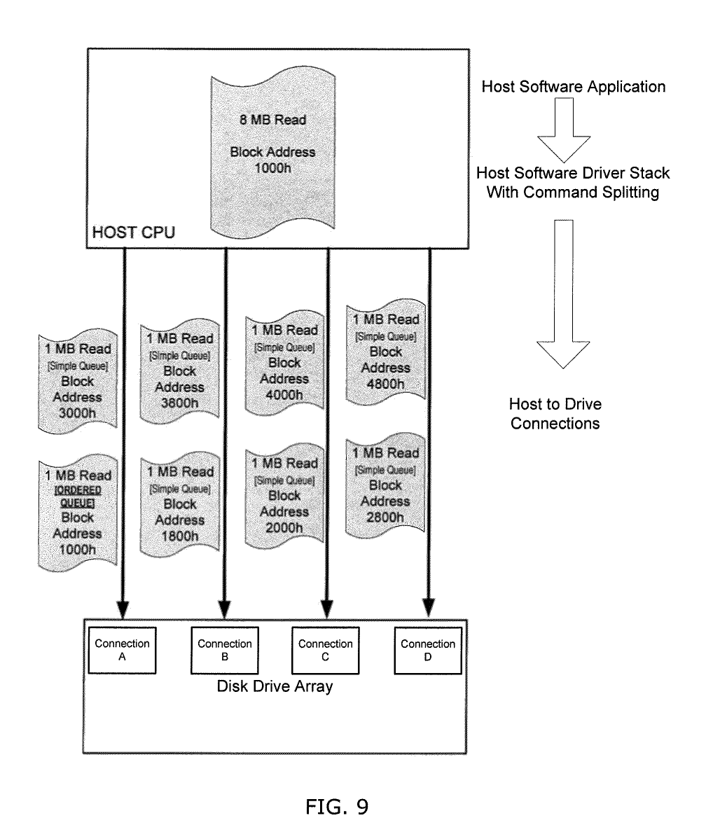

Another embodiment comprises a method for manipulating the queuing policy attributes of the I/O subcommands based on characteristics of the original command and/or the target storage. Characteristics of the original command include logical block address, command size and the requested queuing policy attributes, for example. Characteristics of the target storage include, but are not limited to, RAID algorithm, RAID interval size and number of drives in the RAID group. In an example of this embodiment, a host application sends two 8 MB commands using the system illustrated in FIG. 9, with a host CPU using four connections to a disk drive array. The host driver software splits each 8 MB command into 8 I/O subcommands, 1 MB apiece, with the I/O subcommands in ascending order of block address, creating two groups of 8 I/O subcommands. As illustrated in FIG. 9, The first I/O subcommand issued has its ORDERED attribute set, forcing the command to execute only after the previous group of I/O subcommands has executed. The remaining seven I/O subcommands in a group are sent using SIMPLE tagging/query attributes indicating that the I/O subcommands may be reordered to execute in the most efficient order possible. This forces groups of I/O subcommands to be executed in order, while still allowing some I/O subcommands within those groups to be reordered by the target, enabling the target's RAID engine to execute the commands by the most efficient means possible. I/O subcommands may be grouped in a number of ways including, but not limited to, grouping per command, per stream (a number of commands with contiguous block addresses) or grouping by ranges of block addresses. FIG. 9 illustrates how queuing policy can be used to reduce I/O command latency in a storage subsystem.

Another example of queuing policy manipulation of I/O subcommands is the use of ORDERED tagging to constrain the maximum latency of a group of I/O subcommands. If a number of I/O subcommands are sent using SIMPLE tagging, one of the I/O subcommands may be delayed such that its associated application level command will take a long time to complete. This latency, caused by the RAID engine, may be unacceptable to the host application. Periodically sending a subcommand using ORDERED tagging, irrespective of the subcommand's address, can control overall command latency in the system while still allowing the RAID engine to execute most I/O subcommands by the most efficient means possible.

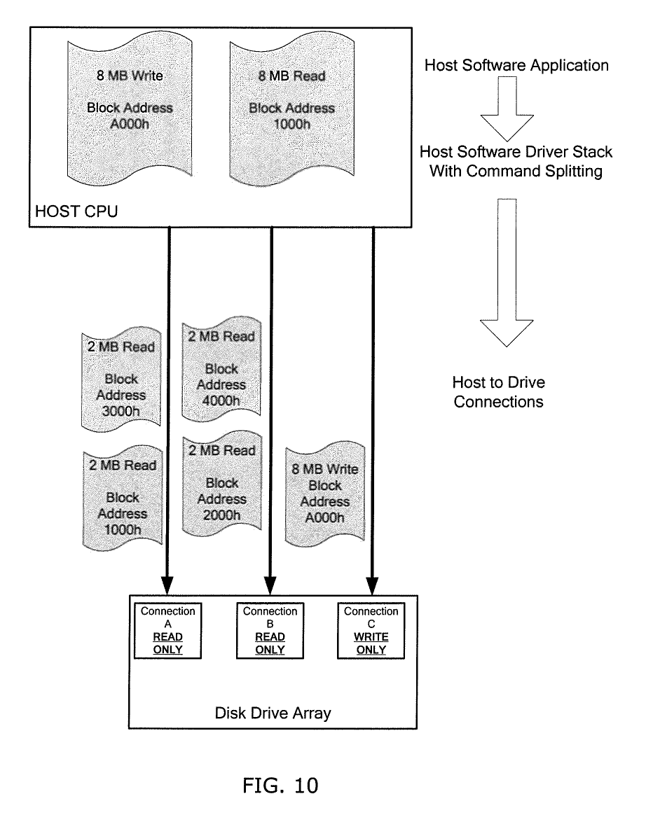

In some aspects of the embodiment, connections to the storage are designated as read-only or write-only connections. The number and size of I/O subcommands generated for a storage command may be based on the number of available read-only or write-only connections. For example, FIG. 10 illustrates a system with a host CPU connected to storage through one write-only and two read-only connections. Connections A and B have been configured as read-only connections. Connection C has been configured as a write-only connection. The host application issues two I/O commands, one 8 MB read and another an 8 MB write. The host software driver generates 4 I/O subcommands for the read and issues them on connections A and B in order to take advantage of the two read-only connections in the system. No I/O subcommands are generated for the write I/O command; instead, the entire 8 MB write I/O command is issued on connection C.

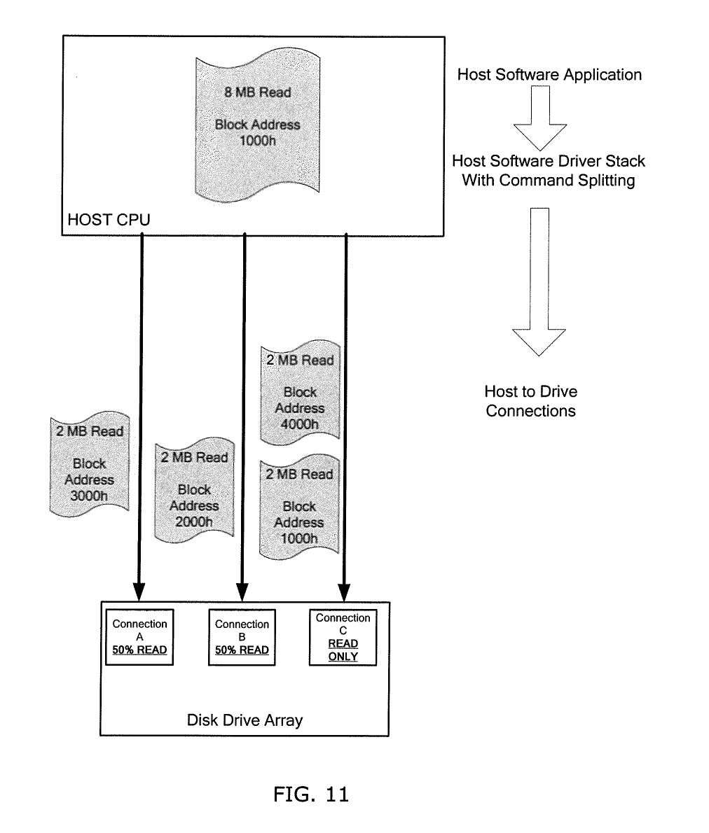

Further, a weighting formula can be specified by the user, either through configuration files, driver registry files, or by a graphical user interface (GUI). The specified weighting formula is used to generate different numbers of I/O subcommands based on a ratio of read- to write-commands or read- to write-bandwidth used per storage connection. In FIG. 11, an example system with a weighted read/write ratio, there are three physical connections between the host storage and the disk drive array. Connections A and B are limited to 50% of total bandwidth available for read commands, while connection C is a read-only connection. An 8 MB read command issued by the host application is split into four I/O subcommands, each 2 MB. Two overlapped I/O subcommands are issued on connection C, using the full bandwidth of the connection, while one subcommand is issued on connections A and B, fulfilling the weighting formula.

In one aspect of this embodiment, the criteria for dividing storage commands into I/O subcommands is configured manually via user input such as a graphical user interface, configuration files, or a command line interface. The manual configuration of command division criteria, such as data physical layout, parity algorithm used, weighting and number of connections, etc. may be on the host system and combined with the dynamic status of the system to decide on the size and number of I/O subcommands to be generated.

In other embodiments, some or all of the criteria for dividing storage commands may be automatically configured by host software. Automatic configuration can take place by querying the host system for the number and speeds of connections, querying the storage for the attributes of the physical layout and monitoring connections for parameters such as connection throughput, number of errors on a connection and connection failure.

While there has been described what is believed to be the preferred embodiment of the present invention, those skilled in the art will recognize that other and further changes and modifications may be made thereto without departing from the spirit or scope of the invention. Therefore, the invention is not limited to the specific details and representative embodiments shown and described herein and may be embodied in other specific forms. The present embodiments are therefore to be considered as illustrative and not restrictive, the scope of the invention being indicated by the appended claims rather than by the foregoing description, and all changes, alternatives, modifications and embodiments which come within the meaning and range of the equivalency of the claims are therefore intended to be embraced therein. In addition, the terminology and phraseology used herein is for purposes of description and should not be regarded as limiting.

We claim:

1. In a computer storage system having a host device capable of issuing I/O commands, a software driver residing on said host device capable of receiving and processing said I/O commands, a plurality of associated storage devices, and a plurality of I/O connections between said host device and said associated storage devices, a method of processing I/O commands comprising:
receiving an I/O command from a host device, said I/O command specifying a data transfer between said host device and a storage device;
determining the amount of data to be transferred between said host device and said storage device;
comparing said amount of data to a threshold data size;
if said amount of data exceeds said threshold data size, generating a plurality of I/O subcommands, each of said I/O subcommands comprising a portion of said I/O command; and
sending said I/O subcommands concurrently over a plurality of I/O connections.

2. The method of claim 1, further comprising:
determining the number of outstanding I/O subcommands on said plurality of I/O connections;
wherein the number of said I/O subcommands generated is determined as a function of said number of outstanding I/O subcommands.

3. The method of claim 1, further comprising:
computing the average time to complete an I/O subcommand on each of said I/O connections;
wherein the number or size of said I/O subcommands generated is determined as a function of said average time to complete an I/O subcommand.

4. The method of claim 1, further comprising:
determining the weighted average of I/O connection throughput;
wherein said I/O subcommands are generated as a function of said weighted average of I/O connection throughput.

5. The method of claim 1, further comprising:
determining the logical characteristics of said associated storage devices;
determining the number or size of said I/O subcommands generated as a function of said logical characteristics.

6. The method of claim 5 wherein said logical characteristics are (a) the number of said associated storage devices, (b) the number of said associated storage devices in use, (c) the type of said associated storage devices, (d) target storage parameters, (e) associated RAID parity algorithms, (f) RAID interval size, or (g) RAID stripe size.

7. The method of claim 1, further comprising:
receiving responses from one or more of said I/O subcommands;
aggregating said responses into a single aggregated response; and
sending said single aggregated response to the issuer of said I/O command.

8. The method of claim 1, further comprising:
determining dynamic I/O throughput;
wherein said threshold data size is calculated as a function of said dynamic I/O throughput.

9. The method of claim 1, further comprising:
measuring the I/O throughput of each of said I/O connections over time;
wherein the size of said I/O subcommands generated is determined as a function of said I/O throughput for a corresponding I/O connection; and
wherein said I/O subcommands generated are of different sizes.

10. The method of claim 1, further comprising:
determining the offset of one of said I/O subcommands, said offset determined from the start of the original I/O command; and
generating a queuing policy for said I/O subcommands as a function of said offset.

11. The method of claim 1, further comprising:
generating a queuing policy for said I/O subcommands as a function of time.

12. The method of claim 1, further comprising:
determining the logical block address of one or more of said I/O subcommands;
generating a queuing policy for said I/O subcommands as a function of said logical block addresses.

13. The method of claim 12, further comprising:
determining a logical block address distance between subsequent I/O subcommands;
comparing said logical block address distance to a predetermined threshold;
if said predetermined threshold is exceeded, generating a queuing policy for said I/O subcommands such that said I/O subcommands are executed in order.

14. The method of claim 1 wherein criteria for generating said I/O subcommands are user configurable through a graphical user interface, configuration files or command line interface.

15. The method of claim 1, further comprising:
determining the number of said I/O connections which are active;
issuing a notification each time said number changes, and storing said notifications in host memory; and
determining the number or size of said I/O subcommands generated as a function of said notifications.

16. In a computer storage system having a host device capable of issuing I/O commands, a software driver residing on said host device capable of receiving and processing said I/O commands, a plurality of associated storage devices, and a plurality of I/O connections between said host device and said associated storage devices, a method of processing I/O commands comprising:
receiving an I/O command from a host device;
generating a plurality of I/O subcommands, each of said I/O subcommands comprising a portion of said I/O command;
determining the offset of at least one of said I/O subcommands, said offset determined from the start of the original I/O command;
generating a queuing policy for generated I/O subcommands as a function of said offset; and
issuing said I/O subcommands concurrently over a plurality of I/O connections in accordance with said queuing policy.

17. In a computer storage system having a host device capable of issuing I/O commands, a software driver residing on said host device capable of receiving and processing said I/O commands, a plurality of associated storage devices, and a plurality of I/O connections between said host device and said associated storage devices, a method of processing I/O commands comprising:
receiving an I/O command from a host device;
generating a plurality of I/O subcommands, each of said I/O subcommands comprising a portion of said I/O command;
generating a queuing policy for said I/O subcommands as a function of time; and
issuing said I/O subcommands concurrently over a plurality of I/O connections in accordance with said queuing policy.

18. In a computer storage system having a host device capable of issuing I/O commands, a software driver residing on said host device capable of receiving and processing said I/O commands, a plurality of associated storage devices, and a plurality of I/O connections between said host device and said associated storage devices, a method of processing I/O commands comprising:
receiving an I/O command from a host device;
generating a plurality of I/O subcommands, each of said I/O subcommands comprising a portion of said I/O command;
determining the logical block address of at least one I/O subcommand;
generating a queuing policy for said I/O subcommands as a function of said logical block address; and
issuing said I/O subcommands concurrently over a plurality of I/O connections in accordance with said queuing policy.

19. In a computer storage system having a host device capable of issuing I/O commands, a software driver residing on said host device capable of receiving and processing said I/O commands, a plurality of associated storage devices, and a plurality of I/O connections between said host device and said associated storage devices, a method of processing I/O commands comprising:
receiving an I/O command from a host device;
generating a plurality of I/O subcommands, each of said I/O subcommands comprising a portion of said I/O command;
sending an I/O subcommand using ORDERED tagging to limit the maximum latency of said I/O subcommands.

20. A system for processing I/O commands in a computer storage system comprising:
a host capable of issuing I/O commands, said host coupled to a plurality of storage devices via a plurality of I/O connections;
a software driver residing on said host for receiving an I/O command, said I/O command specifying a data transfer between said host and a storage device;
said software driver operable for determining the amount of data to be transferred between said host and said storage device;
said software driver operable for comparing said amount of data to a threshold data size;
said software driver operable for generating a plurality of I/O subcommands if said amount of data exceeds said threshold data size, each of said I/O subcommands comprising a portion of said I/O command; and
a host storage adapter for sending said I/O subcommands concurrently over a plurality of I/O connections.

21. A system for processing I/O commands in a computer storage system comprising:
a host capable of issuing I/O commands, said host coupled to a plurality of storage devices via a plurality of I/O connections;
a software driver residing on said host for receiving an I/O command;
said software driver operable for generating a plurality of I/O subcommands, each of said I/O subcommands comprising a portion of said I/O command;
said software driver operable for determining the offset of at least one of said I/O subcommands, said offset determined from the start of the original I/O command;
said software driver operable for generating a queuing policy for generated I/O subcommands as a function of said offset; and
a host storage adapter for sending said I/O subcommands concurrently over a plurality of I/O connections in accordance with said queuing policy.

22. A system for processing I/O commands in a computer storage system comprising:
a host capable of issuing I/O commands, said host coupled to a plurality of storage devices via a plurality of I/O connections;
a software driver residing on said host for receiving an I/O command;
said software driver operable for generating a plurality of I/O subcommands, each of said I/O subcommands comprising a portion of said I/O command;
said software driver operable for for generating a queuing policy for said I/O subcommands as a function of time; and
a host storage adapter for sending said I/O subcommands concurrently over a plurality of I/O connections in accordance with said queuing policy.

23. A system for processing I/O commands in a computer storage system comprising:
a host capable of issuing I/O commands, said host coupled to a plurality of storage devices via a plurality of I/O connections;
a software driver residing on said host for receiving an I/O command;
said software driver operable for generating a plurality of I/O subcommands, each of said I/O subcommands comprising a portion of said I/O command;
said software driver operable for determining the logical block address of at least one I/O subcommand;
said software driver operable for generating a queuing policy for said I/O subcommands as a function of said logical block address; and
a host storage adapter for sending said I/O subcommands concurrently over a plurality of I/O connections in accordance with said queuing policy.
